(19) United States
(12) Patent Application Publication
(10) Pub. No.: US 2011/0291367 A1
(43) Pub. Date: Dec. 1, 2011

(54) SEALING ARRANGEMENT FOR A PIVOTABLE BOAT DRIVE

(75) Inventors: Fernando Gallato, Padova (IT); Adone Bertolo, Padova (IT); Andrea Tognon, Padova (IT)

(73) Assignee: ZF FRIEDRICHSHAFEN AG, Friedrichshafen (DE)

(21) Appl. No.: 13/145,608

(22) PCT Filed: Feb. 11, 2010
(86) PCT No.: PCT/EP2010/051697

§ 371 Date: Jul. 21, 2011

(30) Foreign Application Priority Data
Feb. 18, 2009 (DE) 102009000994.9

(51) Int. Cl. F16J 15/02; F16J 3/00

(52) U.S. Cl. 277/634; 277/628; 277/645

(57) ABSTRACT

A sealing arrangement (1) for a pivotally arranged boat drive in a hull of a boat, the boat drive extends through a hull opening in the bottom of the boat. The boat drive forms, together with the hull of the boat or with a connecting piece (2) set into the hull of the boat, an annular gap. The annular gap is bridged by at least two flexible sealing elements (5, 6), and the at least two sealing elements (5, 6) enclose at least one ring chamber (7) between them.

This application is a National Stage completion of PCT/EP2010/051697 filed Feb. 11, 2010, which claims priority from German patent application serial no. 10 2009 000 994.9 filed Feb. 18, 2009.

### FIELD OF THE INVENTION

The invention concerns a sealing arrangement for a pivotable boat drive.

### BACKGROUND OF THE INVENTION

Known inboard boat drives comprise a steering and propulsion unit arranged underwater, which can be pivoted about a vertical axis. Propulsion is produced by one or two propellers whose rotational axis can be pivoted by the steering unit. Thanks to the ability of the propulsion vector to be pivoted, a steering action for the boat is achieved. The propulsion and steering unit comprises a vertically arranged column which accommodates the driveshaft for the propeller and which passes through a bottom plate set into the boat's hull, this also being known as the connecting piece. In known boat drives the pivotable steering and propulsion unit is supported and sealed relative to the hull opening by elastic rings, i.e. at the same time reaction forces resulting from the propeller thrust are transmitted directly into the hull. A disadvantage of the known sealing arrangement is that the elastic rings are subjected to relatively large forces and must therefore have relatively high elasticity, which is less advantageous for a good sealing action. However, such a seal is prone to increased wear due to relative movements between the seal and the component to be sealed.

From WO 2005/005249 A1 a similarly pivotable boat drive with a traction double propeller is known.

### SUMMARY OF THE INVENTION

The purpose of the present invention is to provide a sealing arrangement of the type mentioned at the start, with an improved sealing action and continuous functional control of the sealing action, in particular during vertical movements of the boat drive caused by oscillations.

According to the invention the boat drive passes through the hull opening with an annular gap bridged by at least two flexible sealing elements, so that a closed ring chamber is formed around the periphery of the boat drive. The effect of this sealed ring chamber is that the boat drive can undergo relative movements in relation to the boat's hull, especially in the vertical direction. This is particularly advantageous for a boat drive suspended elastically relative to the boat's hull, and which therefore undergoes oscillations especially in the vertical direction.

In a preferred embodiment the ring chamber is filled with a control liquid and communicates with a control container. This gives the advantage of continuous control of the sealing action. Preferably, the control container has a liquid level indicator by means of which the liquid level can be checked continuously. For example, if the liquid level in the control container falls, control liquid is leaking out of the ring chamber, i.e. the inner sealing element (the one facing the inside of the boat) is not leak-proof so the control liquid is flowing out into the inside of the boat. On the other hand the level of the control liquid in the control container may rise, in which case seawater is making its way into the ring chamber, i.e. the outer sealing element on the seawater side is leaking, whereas the inner sealing element is still intact. Finally, it may be that both the inner and the outer sealing elements develop leaks, and then too there will be a change of the check level, tantamount to a warning of water penetration.

In a preferred embodiment the control container is arranged inside the boat and connected to the ring chamber by a flexible line. This enables the control container to be arranged in any desired position in the boat and the liquid level in the control container to be read conveniently.

According to a further preferred embodiment the at least two sealing elements are in the form of bellows or siphon-joint seals, preferably having bead-like thickened portions at their inner and outer circumferences. This has the advantage that the seals can be clamped firmly on both sides while on the other hand allowing relative movements in the vertical direction.

Further preferred embodiments comprise a first clamping device at the periphery of the boat drive and a second clamping device around the periphery of the hull opening. This enables the sealing elements with their peripheral beads to be clamped on both sides, producing a leak-proof seal. This also defines the volume of the ring chamber holding the control liquid.

In a further preferred embodiment the hull opening is formed in a hull connecting piece, also called just the connecting piece in what follows, which can be set into the boat's hull. This has the advantage that the ring chamber, the flexible sealing elements and the clamping devices with the connecting piece can be preassembled as a structural unit which is then set into the actual hull.

In a further preferred embodiment the hull connecting piece can be made as a crash component, preferably with a sandwich structure. Since owing to the flexible sealing elements the connecting piece does not sustain any reaction forces from the propeller thrust, it can be made light and deformable. As a crash component it serves to increase the safety of the boat's hull.

### BRIEF DESCRIPTION OF THE DRAWINGS

An example embodiment of the invention is shown in the drawing and will be described in more detail below, so that further features and/or advantages may emerge from the description and/or the drawing, which shows:

FIGS. 1a, 1b: A sealing arrangement according to the invention, fixed to a hull connecting piece, and

FIG. 2: A partial section through a boat drive in combination with the sealing arrangement shown in FIG. 1a.

### DETAILED DESCRIPTION OF THE PREFERRED EMBODIMENTS

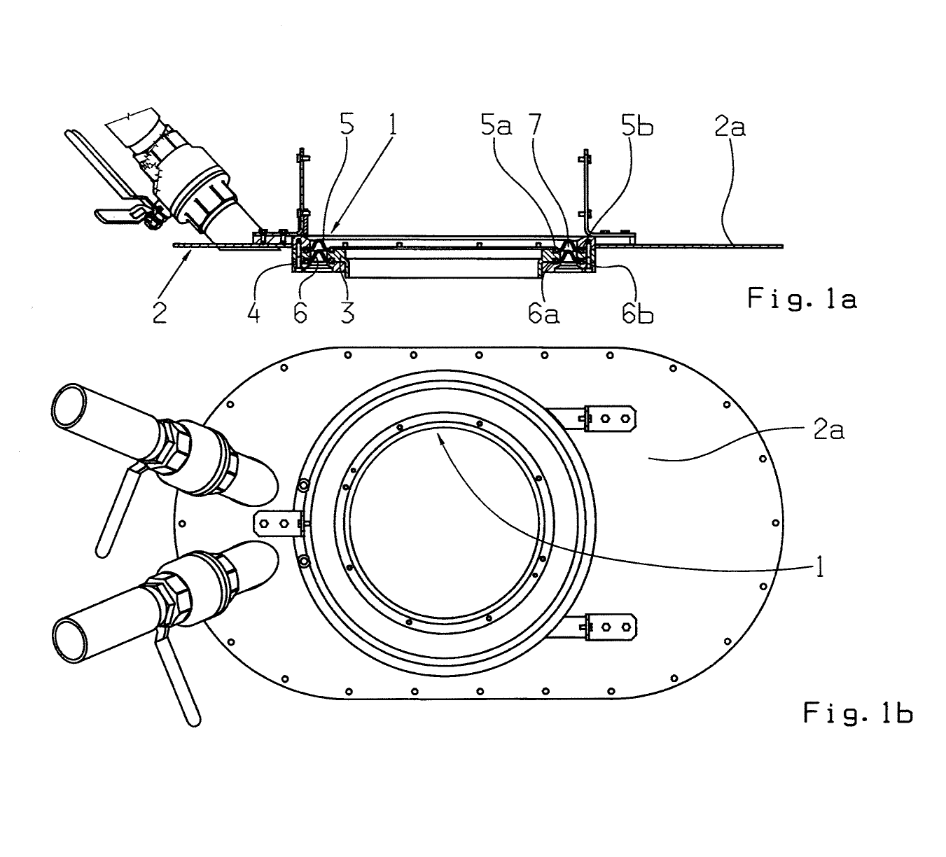

FIG. 1a shows a sealing arrangement 1 according to the invention, viewed in cross-section, while FIG. 1b shows the sealing arrangement 1 viewed from above, fitted into a hull connecting piece 2 also called the connecting piece 2 for short in what follows. The connecting piece 2 is set into an opening (not shown) corresponding to the oval periphery of the connecting piece 2 in a boat's hull (not shown), and is connected to it firmly and in a sealed manner. In a patent application by the present applicant (applicant's internal file number: 002087) filed at the same time, a connecting piece of this type with a sandwich structure is described in detail. The sealing arrangement 1 comprises a first (inner) clamping device 3, a second (outer) clamping device 4 and two flexible sealing elements in the form of bellows seals 5, 6, each having respective ring beads 5a, 5b, 6a, 6b along their inner and outer peripheries. The bellows seals 5, 6, which are clamped with their ring beads 5a, 5b, 6a, 6b in the clamping devices 3, 4, form a closed ring chamber 7. The second (outer) clamping device 4 is connected fast to the connecting piece 2 and forms with it a preassembled structural unit, which is set into the boat's hull (not shown). The connecting piece 2 is shown only incompletely, i.e. essentially only with an upper steel plate 2a. The sealing element 5 arranged at the top in the drawing faces toward the inside space of the boat's hull; the sealing element 6 arranged at the bottom in the drawing is arranged on the seawater side. As will be described below, the ring chamber 7 is filled with a control liquid which serves to enable checking of the sealing action of the two sealing elements 5, 6.

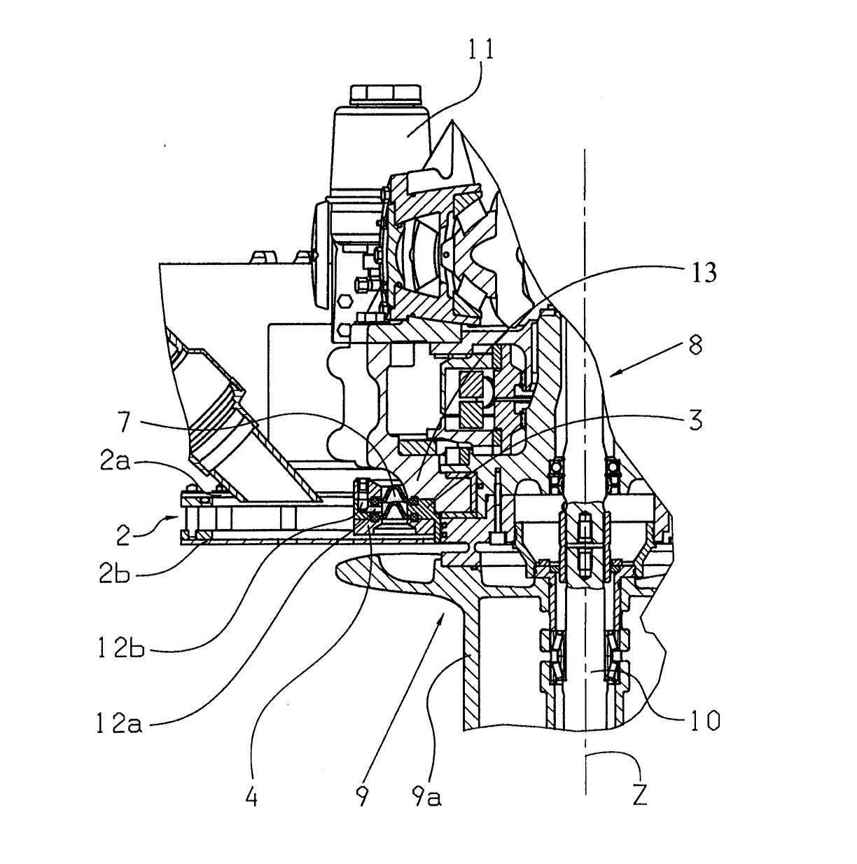

FIG. 2 shows the sealing arrangement 1 in combination with a partially shown boat drive 8 and the connecting piece 2, shown here with the inner steel plate 2a and an outer (seawater side) steel plate 2b. The boat drive 8 comprises a pivotable steering device 9 that can be driven by a transmission (not explained further), with a housing 9a for accommodating a driveshaft 10 for a propeller (not shown), also called the screw. The steering device 9 is mounted to pivot about the vertical axis z relative to a mount 13 supported on the hull, and is fixed in both axial directions. The inner clamping device 3 is fixed onto the mount 13 while the outer clamping device 4 is connected to the connecting piece 2. The entire boat drive 8, including the steering device 9 and the mount 13, is elastically suspended relative to the boat's hull so that the reaction forces from the propeller thrust and the weight of the boat drive 8 are transferred directly into the hull. Accordingly, the connecting piece 2 is isolated relative to those forces, and is free from load. Owing to the elastic suspension the boat drive 8 undergoes oscillations, especially in the vertical direction (z direction), i.e. relative movement takes place between the inner clamping device 3 and the outer clamping device 4, which is allowed by the flexible sealing elements 5, 6.

The ring chamber 7, which is filled with a control liquid, communicates with a control container 11 which has a liquid level indicator (not shown). In the outer clamping device 4 are arranged a transverse and a longitudinal bore 12a, 12b, by means of which the ring chamber 7 can be connected, via a flexible connection line (not shown), to the control container 11. This system enables the function of the sealing elements 5, 6 to be checked. If the liquid level in the control container 11 changes, as a rule, there is a sealing malfunction. If the liquid level in the control container rises, the sealing element 6 on the seawater side is defective such that seawater flows into the ring chamber 7 and from there to the control container 11. If the liquid level in the control container 11 falls, the inner sealing element 5 is defective and the control liquid escapes from the ring chamber 7 to the inside of the boat. If the liquid level in the control container 11 is falling, it may also be the case that both sealing elements 5, 6 are leaking, such that seawater flows to the inside space of the boat. Thus, by virtue of the ring chamber 7 and its control liquid that communicates with the control container 11, it is possible to effectively and continuously check whether the seals are intact, or whether a defect in the form of leakage exists.

In the example embodiment illustrated, only one ring chamber 7 enclosed by two sealing element 5, 6 is shown. It is also possible and within the scope of the invention for more than one ring chamber, one behind another and divided by sealing elements, to be provided. This would give greater security against the development of leaks.

### Indexes

1 Sealing arrangement

2 Hull connecting piece

2a Steel plate

2b Steel plate

3 First (inner) clamping device

4 Second (outer) clamping device

5 Bellows seal

5a Ring bead

5b Ring bead

6 Bellows seal

6a Ring bead

6b Ring bead

7 Ring chamber

8 Boat drive

9 Steering device

9a Housing

10 Driveshaft

11 Control container

12a Transverse bore

12b Longitudinal bore

13 Mount

z Vertical axis

1-10. (canceled)

11. A sealing arrangement for a boat drive (8) pivotably arranged in a hull of a boat, the boat drive (8) extends through a hull opening in a bottom of the boat such that the boat drive (8) forms an annular gap with one of the hull of the boat and a connecting piece (2) set into the hull of the boat;
the annular gap being bridged by at least flexible first and second sealing elements (5, 6);
the first and the second sealing elements (5, 6) enclosing at least one ring chamber (7) therebetween;
the hull opening being arranged in the connecting piece (2) being supportable within the hull of the boat, the connecting piece (2) being a crash component with a sandwich structure, and
the first and the second sealing elements (5, 6) being arranged between an inside space of the hull of the boat and a seawater side of the hull of the boat.

12. The sealing arrangement according to claim 12, wherein the at least one ring chamber (7) is filled with a control liquid and communicates with a control container (11).

13. The sealing arrangement according to claim 12, wherein the at least one ring chamber (7) is connected to the control container (11) by a flexible liquid line.

14. The sealing arrangement according to claim 12, wherein the control container (11) has a liquid level indicator.

15. The sealing arrangement according to claim 11, wherein the first and the second sealing elements are bellows seals (5, 6) which have inner and outer ring beads (5a, 5b, 6a, 6b).

16. The sealing arrangement according to claim 15, wherein a first clamping device (3) is provided around a periphery of the boat drive (8) for holding the first and the second sealing elements (5, 6).

17. The sealing arrangement according to claim 15, wherein a second clamping device (4) is arranged in an area of the hull opening for holding the first and the second sealing elements (5, 6).

18. The sealing arrangement according to claim 15, wherein the inner and the outer ring beads (5a, 5b, 6a, 6b) of the first and the second bellows seals (5, 6) are clamped by at least one clamping device (3, 4).

19. The sealing arrangement according to claim 15, wherein the inner and the outer ring beads (5a, 5b, 6a, 6b) of the first and the second bellows seals (5, 6) are clamped by first and second clamping devices (3, 4).

20. The sealing arrangement according to claim 19, wherein the first and the second sealing elements (5, 6) allow relative movements between first and the second clamping devices (3, 4) in at least one of a vertical direction and a horizontal direction.

21. The sealing arrangement according to claim 15, wherein a first clamping device (3) is provided around a periphery of the boat drive (8) for holding the first and the second sealing elements (5, 6); and
a second clamping device (4) is arranged in an area of the hull opening for holding the first and the second sealing elements (5, 6).
